(19) United States
(12) Patent Application Publication
(10) Pub. No.: US 2012/0159888 A1
(43) Pub. Date: Jun. 28, 2012

(54) CULTURED STONE MASONRY UNIT

(76) Inventor: David Aston, Caddo Mills, TX (US)

(21) Appl. No.: 12/964,631

(22) Filed: Dec. 9, 2010

Related U.S. Application Data
(60) Provisional application No. 61/285,119, filed on Dec. 9, 2009.

(51) Int. Cl. E04B 2/14; B29C 39/10; B29C 39/12; E04C 1/00

(52) U.S. Cl. 52/503; 52/606; 264/219; 264/78

(57) ABSTRACT

Embodiments of the present disclosure generally provide unitary building units having a cultured stone face and the method and apparatus for making such building units.

This application claims priority and the benefit under 35 U.S.C. §119(e) from U.S. provisional patent application 61/285,119 for “Cultured Stone Masonry Unit” filed on Dec. 9, 2009, which is hereby incorporated by reference in its entirety.

The disclosure relates generally to construction materials, and in particular to concrete masonry units.

### BACKGROUND

A concrete masonry unit (CMU), also known as cement block, concrete block, or foundation block, is a large rectangular brick with hollow centers used by the construction trade. Concrete Masonry units provide the basis of many simple structures, including walls for landscaping and buildings.

The basic structure of a concrete masonry unit is a brick approximately 8 inches wide by 8 inches tall by 16 inches long typically having two hollow cores. The hollow cores allow for reinforcement and concrete to tie courses of CMU together to form load-bearing walls. CMU may also be stacked into columns and foundation walls.

CMUs are used to create a wide variety of structures from buildings, referred to as concrete block structures, to retaining walls and decorative structures. CMUs are well known for providing a very secure structure when the reinforcement is properly tied to a good foundation. Therefore, CMUs are often used for industrial and commercial construction.

One shortfall of CMUs is that they have a very drab appearance when left untreated and even when painted the appearance is not generally well liked. Therefore tile, decorative brick, decorative stone, or cultured stone are often applied to a CMU structure to provide a more aesthetic finish to a very functional structure.

### SUMMARY

Embodiments of the present disclosure generally provide unitary building units having a cultured stone face.

### BRIEF DESCRIPTION OF THE DRAWINGS

For a more complete understanding of this disclosure and its features, reference is now made to the following description, taken in conjunction with the accompanying drawings, in which:

FIG. 1 is a perspective view of a cultured stone masonry unit;

FIG. 2 is a perspective view of two cultured stone masonry units;

FIG. 3 is a perspective view of a cultured stone masonry unit used for pillar construction;

FIG. 4 is a top view of a simple wall and pillar layout using cultured stone masonry units;

FIG. 5 is a side view of a wall made according to the layout of FIG. 4;

FIG. 6A is a side view of floor used in making cultured stone masonry units;

FIG. 6B is a top view of the floor shown in FIG. 6A;

FIG. 6C is a top view of a mold box used to make cultured stone masonry units;

FIG. 7A is a photo of a mold box with the floor positioned in the mold box;

FIG. 7B is a photo of the mold box of FIG. 7A with the floor lowered below the mold box; and

FIG. 7C is a photo of the mold box of FIG. 7B with the sides lowered.

### DETAILED DESCRIPTION

The present disclosure generally provides:

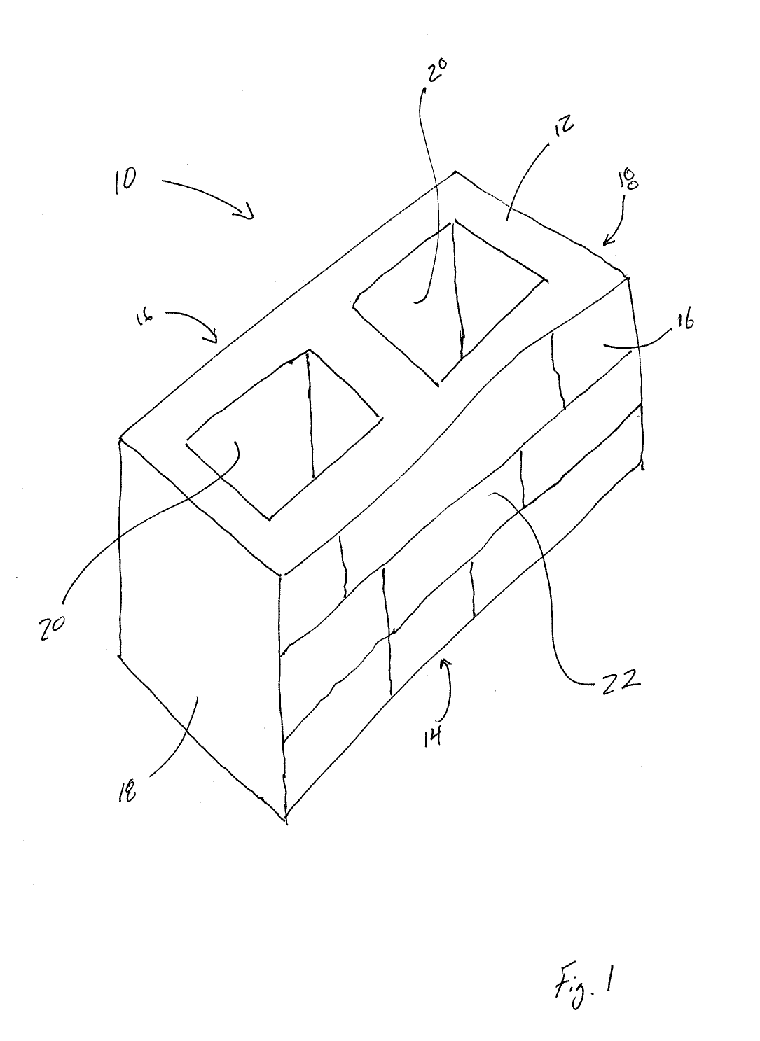

FIG. 1 is a perspective view of a cultured stone masonry unit 10 having a top 12, bottom 14, sides 16, ends 18 and holes 20. The holes 20 extend from the top 12 to the bottom 14. On side 16 visible in this perspective is a cultured surface 22. The cultured surface 22 is cast in side 16. The cultured surface 22 may be formed in both sides 16 of the unit 10 or only a single side 16 of the unit 10.

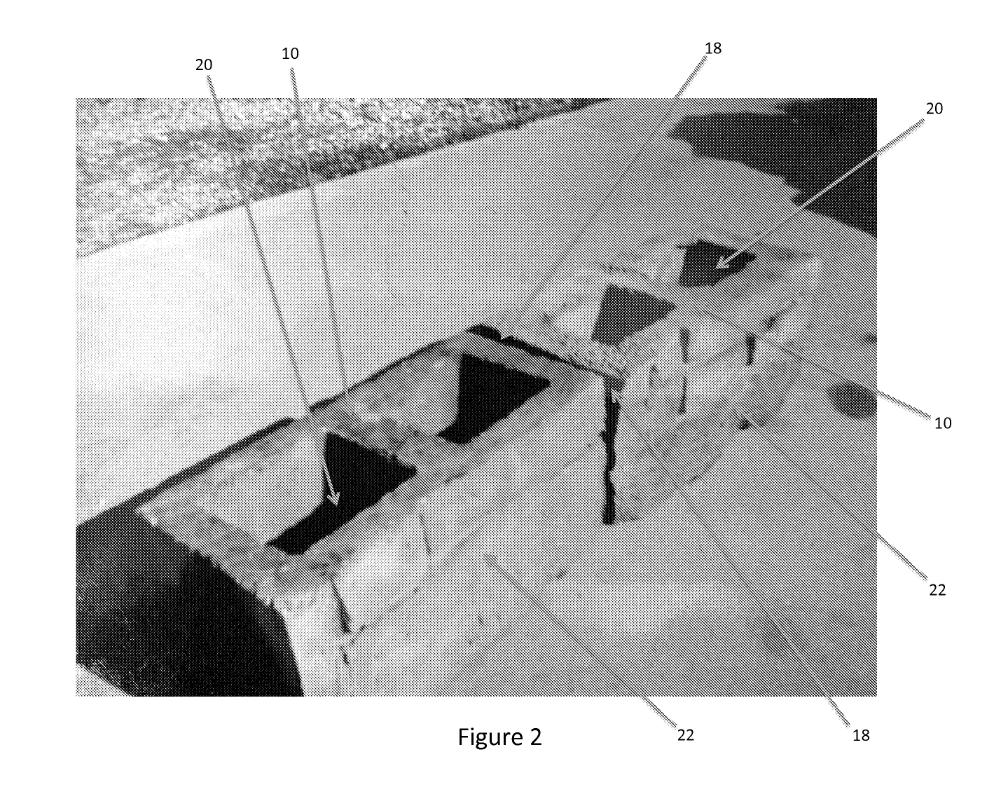

FIG. 2 is a perspective view of two cultured stone masonry units 10 showing how the ends 18 abut cleanly when the units 10 are placed end 18 to end 18, as is common in masonry construction. Ends 18 are as smooth as common concrete masonry units to provide ease of construction.

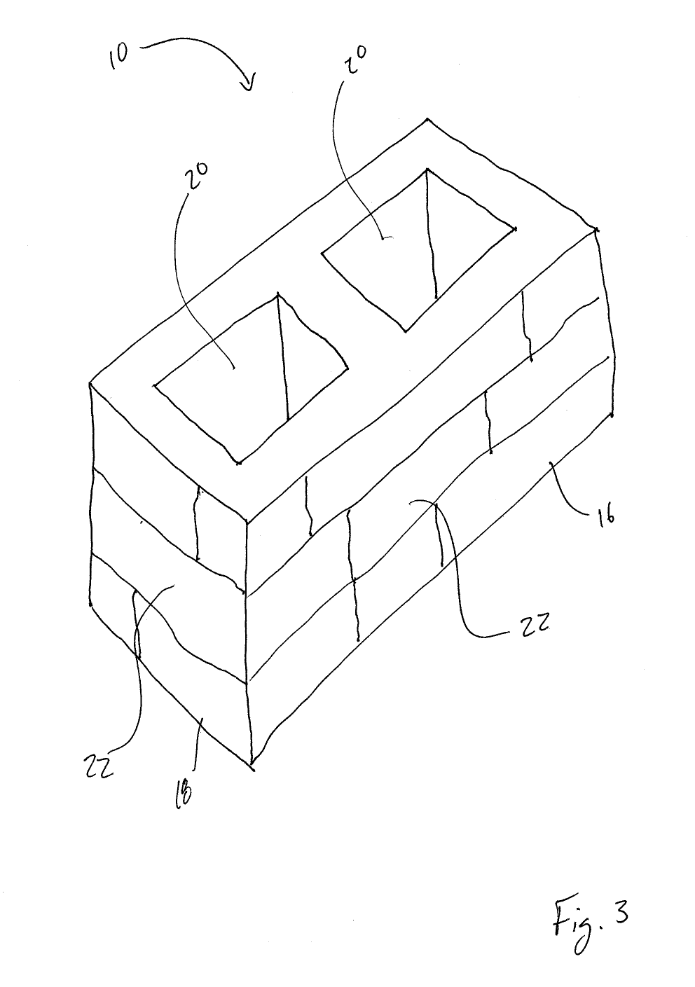

FIG. 3 is a perspective view of a cultured stone masonry unit 10 used for pillar construction. A side 16 and one end 18 of the unit 10 have a cultured surface 22.

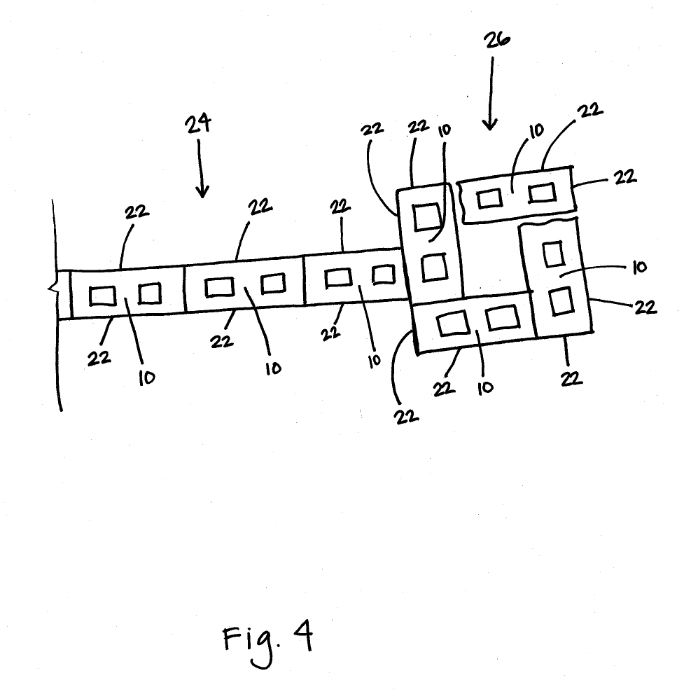

FIG. 4 is a top view of a simple wall 24 and pillar layout using cultured stone masonry units 10. In this layout the units 10 in the wall 24 have cultured surface 22 on both sides 16 while the units 10 in the pillar 26 have cultured surface 22 on one side 16 and one end 18 to allow for all exterior surfaces of the wall 24 and pillar 26 to have cultured surface 22. A particular advantage of this layout is that wall 24 may be constructed and finished from one side of the wall 24, without having to encroach on the land and landscaping on the other side of the wall 24. This is particularly important where a wall 24 is to run along the property line. The adjacent land need not be disturbed to provide a finished cultured stone look on both sides of the wall 24. This is in contrast to building a wall with conventional CMUs and then applying a cultured stone to the finished CMU.

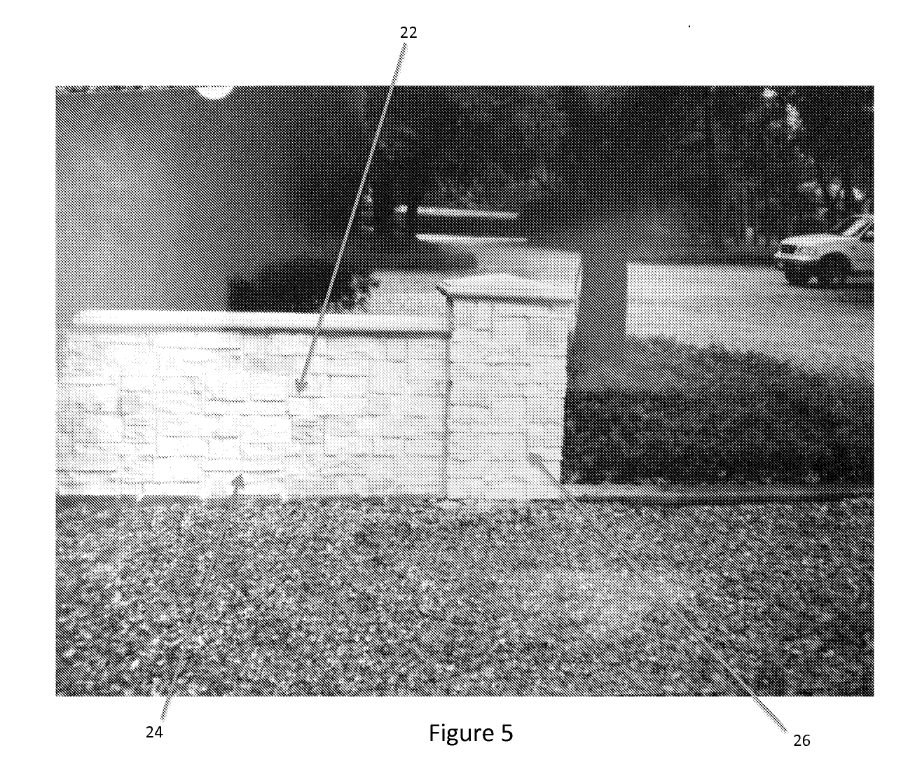

FIG. 5 is a side view of a wall 24 and pillar 26 made according to the layout of FIG. 4. Another advantage of using cultured stone units 10 in this particular layout is that the structural and decorative elements of the wall 24 and pillar 26 may be finished in a single day, without a need to let the structural elements set up before applying the aesthetic elements. This can save time and money for the contractor and owner.

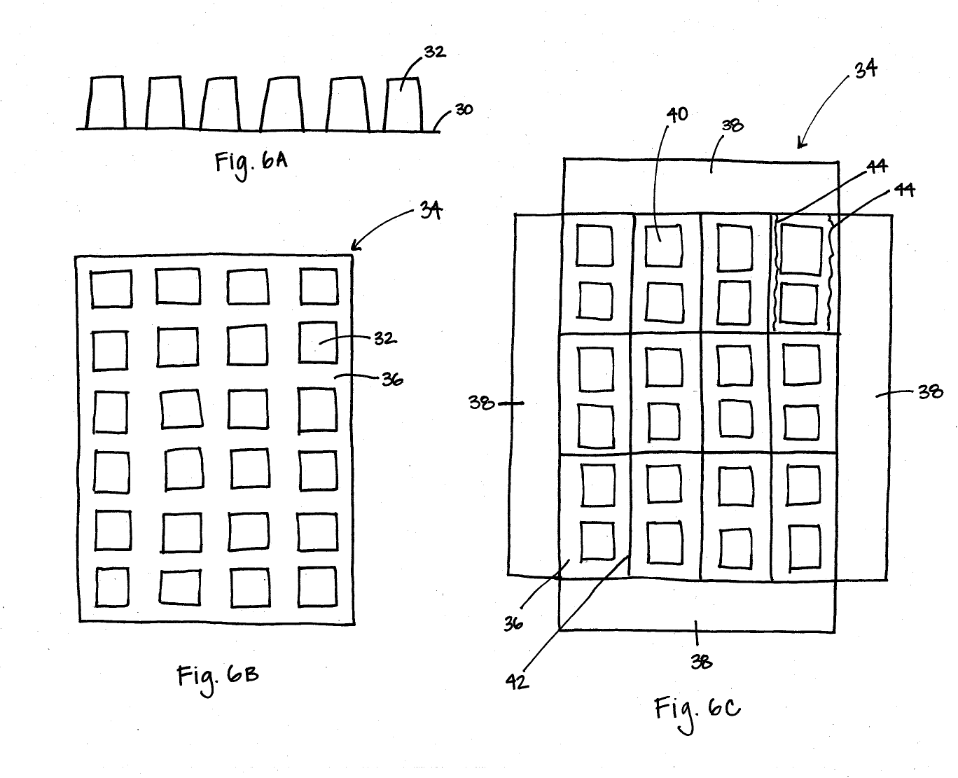

FIG. 6A is a side view of floor 30 used in making cultured stone masonry units 10. The floor has hole elements 32 that extend upward from the floor to form the holes in the units 10.

FIG. 6B is a top view of the floor 30 shown in FIG. 6A. This view shows the spacing of the elements 32.

FIG. 6C is a top view of a mold box 34 used to make cultured stone masonry units 10. The box 34 has a bottom 36 and hinged sides 38. The bottom 36 has cutouts 40 to allow elements 32 of floor 30 to extend through the bottom 36 of box 34. Dividers 42 extend between cutouts 40 to form the sides 16 and ends 18 of units 10. Inserts 44 are placed along dividers to create a cultured surface 22 on sides 16 in the example shown.

In use the floor 30 is placed on a level surface and box 34 is lowered over the floor 30 such that elements 32 extend through cutouts 40. Hinged sides 38 are moved to an upright position and dividers 42 are placed within box 34. Inserts 44 are placed along dividers 42 where cultured surface 22 is desired. The form box 34 is filled with concrete and the concrete is allowed to sure to a reasonable hardness. Form box 34 is lifted off of floor 30 and hinged sides 38 are lowered. The units 10 are removed from the form box 34 and allowed to continue curing before being used. A colorant may be added to the concrete, added to the form box prior to pouring the concrete, or added to the units 10 after removal from the form box 34.

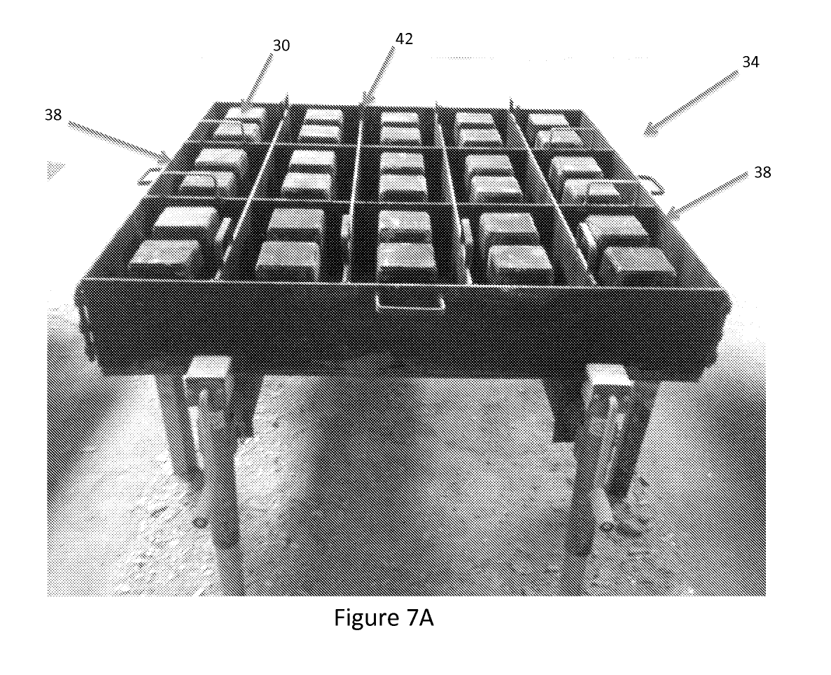

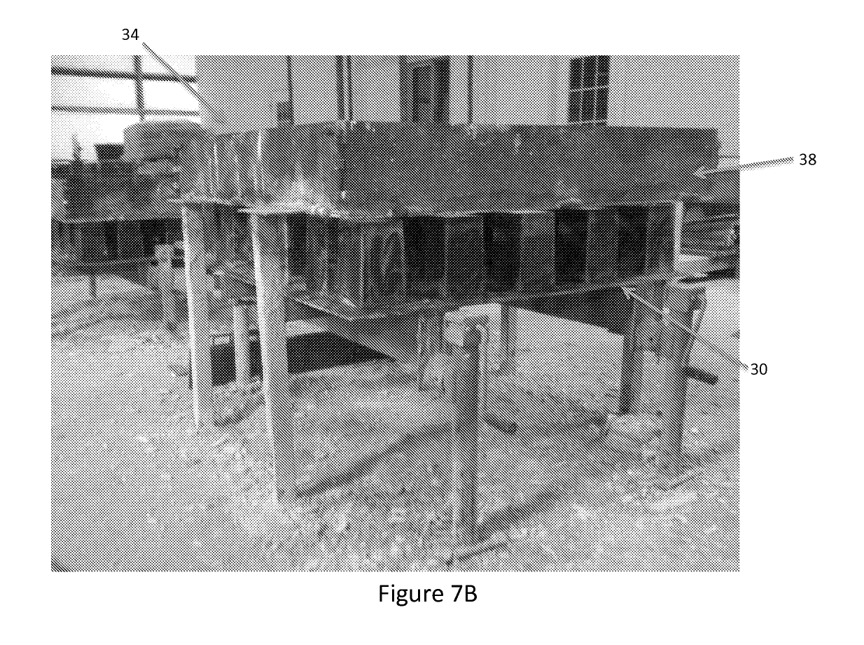

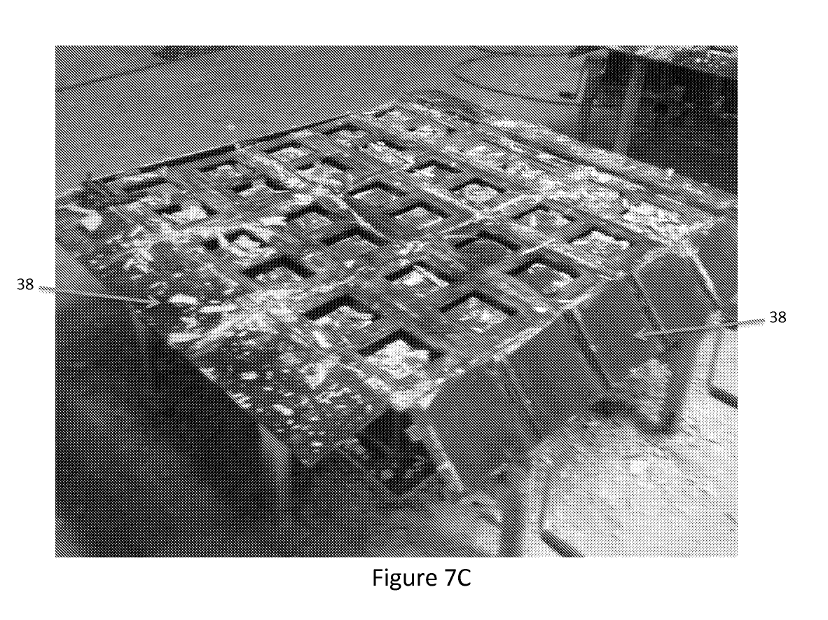

FIG. 7A is a photo of a mold box 34 with the floor positioned in the mold box 34 with dividers 42 and hinged sides 38 in an upright position. In this configuration inserts 44 could be added and concrete could be poured to form CSMUs 10.

FIG. 7B is a photo of the mold box 34 of FIG. 7A with the floor 30 lowered below the mold box 34. In this setup the box 34 is held stable while the floor 30 moves down and out of the box 34 to release the CSMU 10. The hinged sides 38 are still upright and the floor 30 has been lowered to a position slightly below the cutouts 40.

FIG. 7C is a photo of the mold box 34 of FIG. 7B with the hinged sides 38 lowered to release the CSMU 10.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation.

The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A building unit comprising:
a concrete unit having two sides, a top, a bottom and two ends;
two holes extending from the top to the bottom; and
a cultured surface on one side.

2. The building unit of claim 1 further comprising cultured stone on the other side.

3. The building unit of claim 1 further comprising cultured stone on one end of the unit.

4. A wall comprised of:
a plurality of cultured stone building units having cultured stone on at least one side of each unit and holes extending from a top to a bottom of each unit.

5. A method of forming a unitary cultured stone building unit comprising the steps of:
creating a mold with cultured stone inserts and hole elements;
pouring concrete into the mold to create units;
removing the units from the mold.

6. The method of claim 3 further comprising the addition of colorant to the concrete.
